(19) United States
(12) Patent Application Publication
(10) Pub. No.: US 2011/0146514 A1
(43) Pub. Date: Jun. 23, 2011

(54) PRINTING MANDREL FOR RECEIVING A SUBSTANTIALLY CYLINDRICAL HOLLOW BODY, IN PARTICULAR A TUBE BODY

(75) Inventors: Bruno Müller, Tafers (CH); Philippe Cotting, Ependes (CH); Thomas Walther, Fribourg (CH)

(73) Assignee: POLYTYPE S.A., Fribourg (CH)

(21) Appl. No.: 13/060,297

(22) PCT Filed: Aug. 19, 2009
(86) PCT No.: PCT/EP2009/060703

§ 371 Date: Feb. 23, 2011

(30) Foreign Application Priority Data
Aug. 29, 2008 (EP) 08105183.1

(51) Int. Cl. B41G 7/00

(52) U.S. Cl. 101/368

(57) ABSTRACT

A printing mandrel (1) for receiving a substantially cylindrical hollow body comprises a coupling part (2) with which the printing mandrel is insertable in a printing machine. Attached to the coupling part (2) is a receiving part (3) comprising a substantially cylindrical surface (4), onto which receiving part the body is able to be pushed and from which receiving part the body is able to be removed. Made in the end region (5) of the mandrel (1) remote from the coupling part (2) are openings disposed in the surface (4) in a way distributed over the periphery, which openings are connected to an air supply disposed in the mandrel (1). By means of the compressed air exiting the openings (7) a body to be pushed onto the printing mandrel is expanded, which facilitates an easy pushing on; with a cutting off of the compressed air supply an optimal seating between the body and the printing mandrel (1) results, which facilitates an optimal processing of the body.

This invention relates to a printing mandrel for receiving a substantially cylindrical hollow body, in particular a tube body, comprising a coupling part, with which the printing mandrel is insertable into a printing machine, and a receiving part, attached to the coupling part, having a substantially cylindrical surface, onto which receiving part the body is able to be pushed and from which receiving part the body is able to be removed.

For printing of cylindrical hollow bodies, in particular tube bodies, these bodies are put on printing mandrels, which are inserted in corresponding printing machines, which printing mandrels, with the placed-on bodies, are then led past printing stations in which the surfaces of these hollow bodies are printed. One or more printing stations can thereby be passed through, and the surfaces of these hollow bodies can be printed in a multi-colored way. In order to be able to carry out these printing steps precisely and in good register, it is necessary for the hollow body to be printed to sit tightly on the printing mandrel in a non-slidable and non-rotatable way. However, the body to be printed should be able to be placed simply and quickly on the printing mandrel by a correspondingly designed device. The removal of a printed hollow body from the printing mandrel should likewise be able to be carried out in a simple way.

Printing mandrels are known which are able to be spread apart after the hollow body to be printed has been placed on them. Individual regions of these printing mandrels can thereby be pressed outwardly. The hollow body put on this printing mandrel is held in a pressed way. A shifting of this body in relation to the printing mandrel can thereby be avoided. Such printing mandrels are known, for example, from DE-A-10 2005 052506 and DE-U-20 2004 019 382.

Achieved through the spreading apart of the printing mandrel is an optimal seating of the body put thereon. However, through the spreading apart of the printing mandrel small edges and cracks arise on its surface. With thick-walled bodies to be printed these edges and cracks have no influence on the printed picture. With thin-walled bodies to be printed and those of elastic material, however, these edges and cracks can result in an imprint on the surface to be printed, which can interfere in a noticeable way with the printed picture put on the body. Distorted imprints of this kind can arise in particular with printing processes in which the printing mandrel, with the body to be printed put thereon, comes into direct contact with a print roller.

The object of the present invention thus consists in creating a printing mandrel for receiving a substantially cylindrical hollow body, in particular a tube body, onto which mandrel this body is able to be pushed on without any problems, is held during the processing step in a non-displaceable way, and is able to be easily removed from the printing mandrel after the processing step, and with which mandrel the aforementioned drawbacks can be avoided.

This object is achieved according to the invention in that made in the end region of the mandrel remote from the coupling part are openings disposed in the surface in a way distributed over the periphery, which openings are connected to an air supply disposed in the mandrel, which air supply is connected to a compressed air source.

Achieved with this design of the printing mandrel according to the invention is that <by means of> the compressed air flowing through the openings the body to be pushed on the mandrel is expanded in the elastic region; the pushing of the body onto the mandrel can be carried out without any great effort through the air cushion effect. After the body is completely pushed onto the mandrel, the compressed air supply is cut off; the body is disposed on the mandrel in a close-fitting way and is held optimally, so that the printing steps are able to be carried out with the desired quality of printing. To remove the body from the mandrel, the compressed air supply can be switched on again. The body is once again expanded in the elastic region by means of the compressed air flowing out. The removal of the body from the printing mandrel can be carried out effortlessly.

The mandrel is preferably designed as a hollow body, which is closed off with a cap at the end region remote from the coupling part, which results in a simple construction.

The cap is preferably provided with a flange whose flange surface comes to abut the front face of the hollow body. The cap can thereby be easily positioned on the mandrel.

A further advantageous embodiment of the invention consists in that the openings are formed by recesses made in the flange surface, which recesses come out into bores which form a connection to the air supply. This results in a simple creation of the openings in the mandrel.

The cap is preferably provided with a threaded part, which is screwable into a threaded part correspondingly provided in the hollow body. The cap can thereby be easily removed from the mandrel, and the openings easily cleaned with little effort.

The cap is preferably provided with centering means, whereby an exact fit of the cap in relation to the mandrel is achievable.

A simple design for the mandrel is achieved by the air supply being formed through the hollow space of the hollow body. Hence no additional compressed air supply lines are necessary.

A further advantageous embodiment of the invention consists in at least one further opening being made in the front side of the cap, which opening is connected to an air supply line. On the one hand, when pushing the body onto the mandrel, the air retained in the body can flow away through this opening, which makes the pushing of the body onto the mandrel easier. On the other hand, for removal of the body from the mandrel, compressed air can be supplied via this further opening, whereby the body is removed from the mandrel.

In a simple way, the air supply line can be led through the hollow body of the mandrel and be connected to a compressed air source.

An embodiment of the printing mandrel according to the invention will be described more closely in the following, by way of example, with reference to the attached drawing.

Shown are:

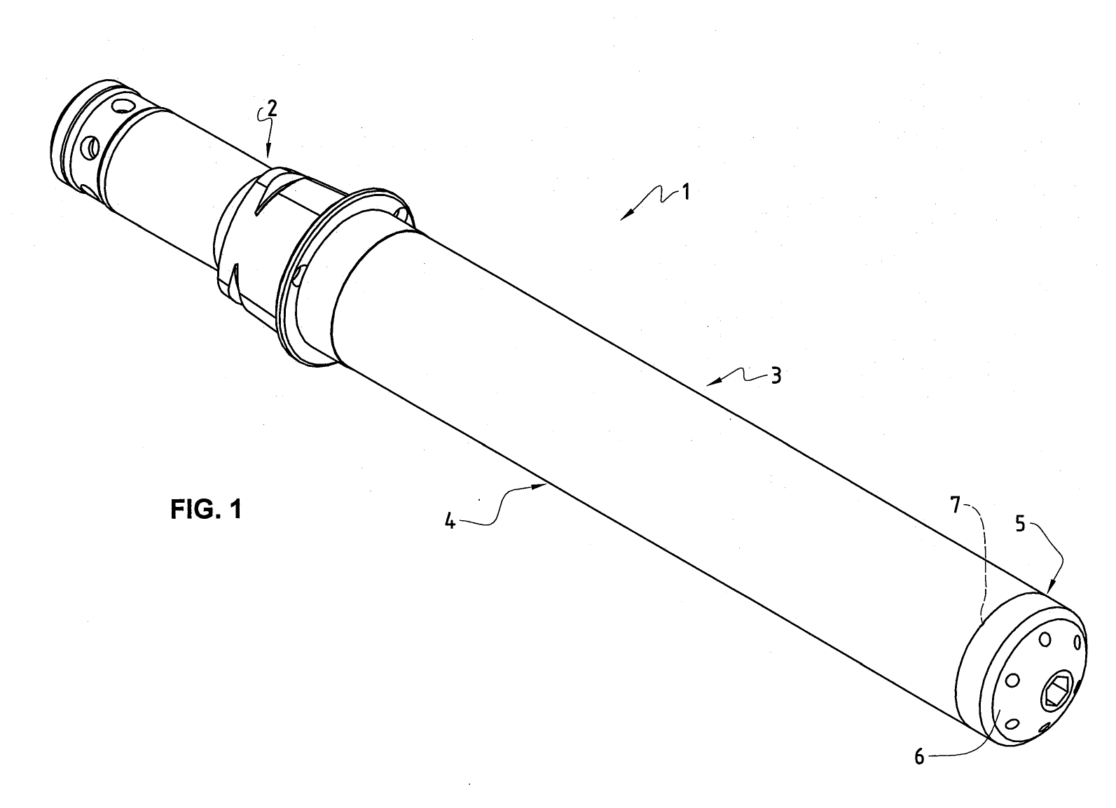

FIG. 1, a printing mandrel designed according to the invention in a three-dimensional representation;

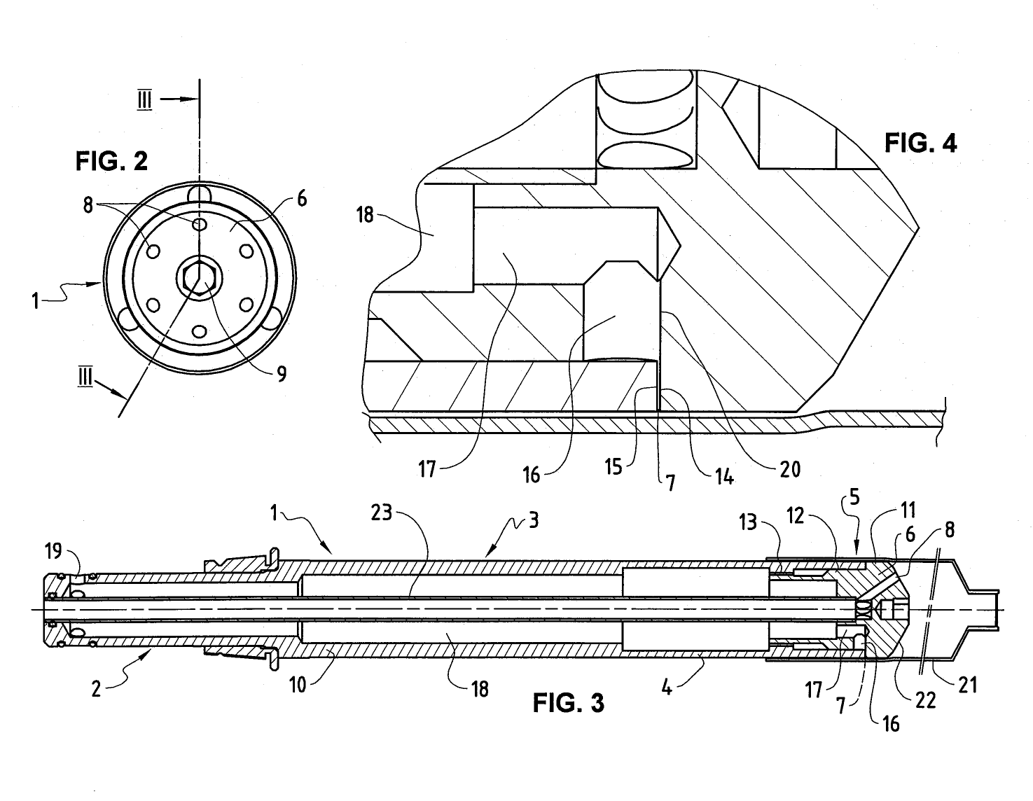

FIG. 2, a view from the front of the printing mandrel according to FIG. 1;

FIG. 3, a sectional representation of the printing mandrel along the line III-III according to FIG. 2 with tube body partially pushed on;

FIG. 4, an enlarged sectional representation of the end region of the printing mandrel with tube body pushed on; and

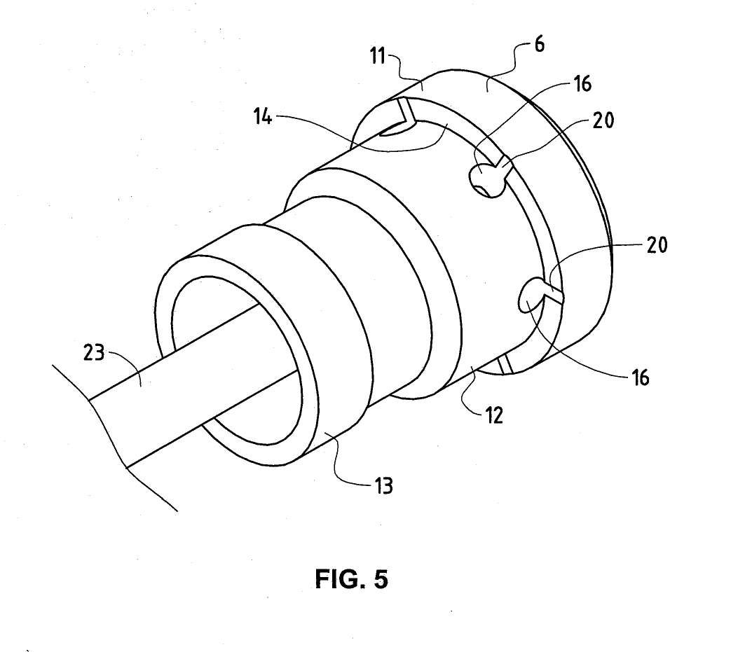

FIG. 5, in a three-dimensional representation, a view of the cap with which the printing mandrel is closed off.

As can be seen from FIG. 1, the printing mandrel 1 designed according to the invention comprises a coupling part 2 and a receiving part 3. The coupling part 2 is designed in a known way such that the printing mandrel 1 can be inserted into a known printing machine and can be locked in a releasable way in the inserted state. The printing machine is thereby provided in a known way with a plurality of receiving areas of this kind for one printing mandrel 1 each in such a way that these printing mandrels can be led past printing devices in a known way, these printing mandrels being moreover rotatable about the longitudinal axis.

The receiving part 3 of the printing mandrel 1, onto which a cylindrical hollow body to be printed can be pushed, as will be described later in detail, is provided with a substantially cylindrical surface 4. The end region 5 remote from the coupling part 2 is provided with a cap 6. In this region openings 7 are made, disposed in a way distributed over the circumference, as will be described later in detail.

Shown in FIG. 2 is a view of the cap 6. Disposed in this cap 6 are further openings 8 on its front side, which will be described in detail later. In addition, this cap 6 can be provided with a polygonal (for example) depression 9, into which a corresponding tool can be inserted in a known way, in order to fasten or respectively remove the cap.

As can be seen from FIG. 3, the printing mandrel 1 is made up of a hollow body 10. As already mentioned, the front end region 5 is closed with a cap 6. This cap 6 is provided with a flange 1. Installed adjacent to the flange 1 is a cylindrical guide piece 12, on the continuation of which a threaded part 13 is disposed. This cap can thus be screwed into the hollow body 10, for which purpose this hollow body is provided with a corresponding threaded part. The guide piece 12 is thereby held in the hollow body in a guided way and is thereby precisely centered. In the screwed-on state of the cap 6 on the hollow body 10, the flange surface 14 of the flange 1 comes to abut the front face 15 of the hollow body 10.

Made in the cap 6 in the region of the flange surface 14 are radial bores 16, which are distributed over the circumference. These bores 16 are connected to further bores 17, which are made axially in the cap 6, and which come out into the hollow space 18 of the hollow body 10. Made in the region of the coupling part 2 of the printing mandrel 1 are inlet openings 19, which are connectible in a known way to a compressed air supply of the printing machine, and via which compressed air can be conducted into the hollow space 18.

As can be learned from FIGS. 4 and 5, the radial bores 16 are made in the cap 6 in such a way that by means of the creation of these bores 16 a small recess 20 occurs in each case in the flange surface 14. Formed by this recess 20 is the opening 7 via which the compressed air conducted into the hollow space 18 can escape over the surface 4.

When, for example, a tube body 21 is supposed to be pushed on the receiving part 3 of the printing mandrel 1, compressed air is led into the hollow space 18 via the inlet openings 19, as can be seen from FIG. 3; this air escapes via the openings 7, as has been previously described. The tube body 21 is pushed in a known way over the cap 6 using a push-on device. The front edge of this tube body 21 arrives over the openings 7. The compressed air exiting here causes the thin-walled elastic tube body 21 to be expanded, and thus it can be pushed onto the receiving part 3 of the printing mandrel 1 practically without resistance. Between the surface 4 of the receiving part 3 and the inner surface of the tube body 21 there occurs, as it were, an air cushion. When the tube body 21 is pushed completely on the receiving part 3 of the printing mandrel 1, the supply of compressed air into the hollow space 18 is cut off. The air between tube body 21 and surface 4 escapes. The tube body 21 presses itself on the receiving part 3. Thereby achieved is an optimal fit of the tube body 21 on the receiving part 3 of the printing mandrel 1. Shown schematically in FIG. 4 is how the tube body 21 is expanded by the compressed air brought in through the openings 7.

When pushing the tube body 21 onto the receiving part 3 of the printing mandrel 1, the diameter change of the tube body 21 ranges within a few tenths of a millimeter.

When the processing step on the tube body 21 is completed and the tube body 21 is supposed to be removed from the receiving part 3 of the printing mandrel 1, compressed air can be brought in again via the inlet openings into the hollow space 18, which air again exits via the openings 7 and expands the tube body 21 to the extent that it can be easily removed from the printing mandrel 1.

As can be seen from FIGS. 2 and 3, the cap 6 has further openings 8, which are made slanting from the front side 22 of the cap 6 toward the central axis. These further openings 8 are connected to an air supply line 23, which is disposed centrally in the hollow space 18 of the printing mandrel 1. This air supply line 23 is connectible in a known way in the coupling part 2 of the printing mandrel 1 to a corresponding compressed air supply of the printing machine. Via these further openings, when pushing a tube body 21 onto the printing mandrel 1, the air located in the tube body 21 can be discharged via the opened air supply line 23. When the processing step for a tube body placed on the printing mandrel 1 is completed and the tube body 21 is supposed to be ejected, compressed air can be blown into the tube interior via the air supply line 23 and the further openings 8, whereby the tube body is pulled off the printing mandrel independently.

As has already been mentioned, the cap 6 can be easily screwed off the printing mandrel 1. This can be necessary when, for example, the openings 7 are soiled and a cleaning must be carried out. Through the design of these openings 7, which, as can be seen in particular in FIG. 5, are made as recesses 20 in the flange surface 14 of the cap 6, this cleaning can be carried out in an optimal way. Afterwards the cap 6 can be screwed on the printing mandrel 1 again, the precise positioning being ensured by the guide piece 12.

Easily achieved with this design according to the invention is that cylindrical hollow bodies to be processed allow themselves to be pushed onto a mandrel, the cylindrical hollow body thereby being seated in an optimal way, free of play, on the mandrel; a processing, for example a printing, of this body can thereby be carried out with optimal quality. Also the removal of the body from the mandrel can thereby be accomplished very easily.

1. A printing mandrel for receiving a substantially cylindrical hollow body (21), in particular a tube body, comprising a coupling part (2), with which the printing mandrel (1) is insertable into a printing machine, and a receiving part (3), attached to the coupling part (2), having a substantially cylindrical surface (4), onto which receiving part the body (21) is able to be pushed and from which receiving part the body (21) is able to be removed, wherein made in the end region (5) of the mandrel (1) remote from the coupling part (2) are openings disposed in the surface (4) in a way distributed over the periphery, which openings are connected to an air supply disposed in the mandrel (1), which air supply is connected to a compressed air source.

2. The printing mandrel according to claim 1, wherein the mandrel (1) is designed as a hollow body (10) and is closed off with a cap (6) at the end region (5) remote from the coupling part (2).

3. The printing mandrel according to claim 2, wherein the cap (6) is provided with a flange (1) whose flange surface (14) comes to abut the front face (15) of the hollow body (10).

4. The printing mandrel according to claim 3, wherein the openings (7) are formed by recesses (20) made in the flange surface (14), which recesses open out into bores (16, 17), which form a connection with the air supply.

5. The printing mandrel according to claim 2, wherein the cap (6) is provided with a threaded part (13) and is screwable into a threaded part correspondingly provided in the hollow body (10).

6. The printing mandrel according to claim 2, wherein the cap (6) is provided with centering means (12).

7. The printing mandrel according to claim 2, wherein the air supply is formed by the hollow space (18) of the hollow body (10).

8. The printing mandrel according to claim 2, wherein made in the front side (22) of the cap (6) is at least one further opening (8), which is connected to an air supply line (23).

9. The printing mandrel according to claim 8, wherein the air supply line (23) is disposed in the hollow body (10) and is connectible to a compressed air source.
